(19) United States
(12) Patent Application Publication
(10) Pub. No.: US 2005/0286346 A1
(43) Pub. Date: Dec. 29, 2005

(54) High intensity directional electroacoustic sound generating system for communications targeting

(76) Inventors: James J. Croft III, Poway, CA (US); Todd Beauchamp, Poway, CA (US); Terry Conrad, Poulsto, WA (US)

Correspondence Address: THORPE NORTH & WESTERN, LLP., 8180 SOUTH 700 EAST, SUITE 200, SANDY, UT, 84070, US

(21) Appl. No.: 11/131,453

(22) Filed: May 16, 2005

Related U.S. Application Data
(63) Continuation-in-part of application No. PCT/US03/37007, filed on Nov. 17, 2003.
(60) Provisional application No. 60/426,980, filed on Nov. 15, 2002.

(51) Int. Cl. B06B 1/06; G08B 3/00

(52) U.S. Cl. 367/140; 340/384.1

(57) ABSTRACT

A compact lightweight electro-acoustic transducer system for generating high intensity, highly directional audio output. The transducer system can generate acoustic intensity levels that can drive the transmission medium to non-linearity such that highly directional secondary sound also can appear in the audible range allowing direct and parametric sound generation from a single acoustic emission system. The device can be used for both distant and/or high intensity communications to convey information, provide high intensity acoustical targeting and/or disrupt or mask other communications.

This application is a continuation-in-part of copending PCT Application No. PCT/US03/037007 filed on 17 Nov. 2003 entitled “A High Intensity Directional Electroacoustic Sound Generating System for Communications Targeting,” which claims the benefit of U.S. Application No. 60/426,980 filed Nov. 15, 2002, in the United States Patent Office is hereby claimed.

### BACKGROUND OF THE INVENTION

1. Field of the Invention

The present invention relates to sound systems, and more particularly to high output, high directivity sound systems utilized for distant and/or high intensity communications.

2. Related Art

When looking to the prior art for high intensity, highly directional acoustic systems, there has not been available a high output, highly directive, small and lightweight device. There have been relatively high intensity audible range systems using large singular horns in which all three dimensions are large comparable to a wavelength to generate high output over any given range and much larger when including any lower range capability. Further, these horn systems have been large three-dimensional packages and/or have not exhibited exceptionally high directivity, which can further increase both frontal and depth dimensions. Additionally, the large frontal area (mouth of the horn) prevented efficient clustering together of a significant number of motor structures to achieve a large motor system area for maximum drive with minimal thermal dissipation per drive unit area.

Normally, any system for generating audible tones in the audible range is operated such as to avoid any non-linearities in the system or in the air so as to result in only having audible tones that are directly generated. Great care is spent in minimizing any possible non-linearity.

Systems that have been designed for high output have concurrently been designed for some level of dispersive sound field coverage most often utilizing large horn systems.

The prior art audio devices have developed systems that avoid generation of nonlinearity in the medium, which can create secondary outputs considered to be distortion.

A prior art device that is highly directional in the sensitive frequency range of human hearing would normally be about a half to a full meter in dimension to maintain high directivity in that frequency range. But to have the same directionality for signals in the lowest voice ranges of approximately a few hundred Hz, the system would have to be four to five meters in dimension. For example, the dimensions of a horn optimized at 1500 to 4000 Hz range would have to be expanded up to ten times or more to operate with the same directionality in the 200 to 800 Hz range and therefore would become quite unwieldy and in most cases would not be practical.

Prior devices if directive, and of high intensity, are already large in all three dimensions and must be very much larger in all three dimensions if producing directivity down into the lower voice range.

In the prior art attempts at directivity there are also ultrasonically derived parametric loudspeakers, which have utilized inaudible ultrasonic frequencies to generate lower level audible tones. Prior art systems of parametrically generated output have had their primary tones kept above the audible range so they cannot be heard and only the secondary tones are meant to appear in the audible range. They are highly directive but are very limited in the audible sound pressure levels that can be generated due to the poor efficiency of nonlinear conversion from ultrasonic to audio frequencies. Lower voice range sound generation above 80 dB is difficult to realize in the prior art parametric systems. They are further limited because at ultrasonic frequencies, the air medium can easily become saturated at high intensities, which then further limits and compresses the dynamic capability of the parametric conversion, placing a fundamental limitation on parametric output from prior art devices. Furthermore, prior art parametric devices use primary tones that are in the ultrasonic range to eliminate audibility of the primary tones, but this also limits the volume velocity of system output to the low volume velocity levels of the ultrasonic frequencies.

There is a need for a highly directive, high output, acoustic output device of compact size, low weight and high efficiency.

### SUMMARY OF THE INVENTION

It would be advantageous to provide a smaller, lighter weight sound generator system that can realize high intensity, highly directional sound generation in a region sensitive to human hearing. It would be of further utility to simultaneously provide lower frequency, directional signals from the same device, even for frequencies with wavelengths that are comparable or larger than the largest dimension of the device. It is further desired to have a device that can be highly directional while providing high intensity output in a package that has at least one dimension substantially smaller than the largest dimension of the complete emission package. It is further desired to have a substantially two-dimensional package that is of lightweight construction and can provide high intensity, highly directive outputs in the most sensitive range of human hearing. It would be desirable to have all the above stated package qualities incorporated in an acoustic communications targeting device exhibiting the ability to generate acoustic levels substantially greater than 140 dB while simultaneously maintaining very high directivity such that the greatest output is concentrated at a forward coverage angle of much less than 15 degrees.

It would be a further advantage to control the intensity variation in the system such that it is at optimized maximum perceived intensity over time while also minimizing thermal rise in the device.

Speech through the same device, communicated parametrically down into the lower voice range while generating with direct energy can maintain directivity that is superior to prior art devices.

With the invention, use of small transducers with cutoff frequencies above the lower voice range, but in the audible range, can be capable of generating significant nonlinearly generated secondary output below cutoff and can be useable to generate broadband speech below the transducer cutoff frequency.

It would be useful to have these abilities and further complementary attributes that are advantageous to a device of this type and purpose, such attributes that will become apparent in the below disclosure.

### BRIEF DESCRIPTION OF DRAWINGS

FIG. 1 shows a prior art high output horn device illustrating a large size in all three dimensions.

FIG. 2 shows a frontal view of an embodiment of the invention utilizing a multiplicity of piezoelectric transducers.

FIG. 3 shows a side view of an embodiment of the invention utilizing a multiplicity of piezoelectric transducers.

FIG. 4 shows the frequency response of the system in FIG. 2.

FIG. 5 shows the polar response of the system in FIG. 2.

FIG. 6 shows a graph of an example of the primary and parametrically generated secondary output.

FIG. 7 shows a block diagram of a preferred system embodiment of the invention.

FIG. 8 shows a block diagram of an embodiment of the system incorporating a range finder.

FIG. 9 shows a side view of an embodiment of the invention utilizing staggered transducers front to back to increase packing density of the transducers.

FIG. 10 is a side view of a transducer having multiple emitting sections on different planes for focusing or steering the emitted wave.

FIG. 11 is a front view of a transducer having concentric emitting sections for focusing of optimizing the emitted wave at a predetermined distance from the surface of the emitter.

FIG. 12a is a transducer having adjacent emitting sections for beam steering the propagated wave

FIG. 12b is another view of a transducer used for beam steering the propagated wave.

FIG. 13 is a flow chart depicting a method for generating highly directional acoustic signals in the audio range of both direct and secondary parametric acoustic generation in a sound-supporting medium.

### DETAILED DESCRIPTION

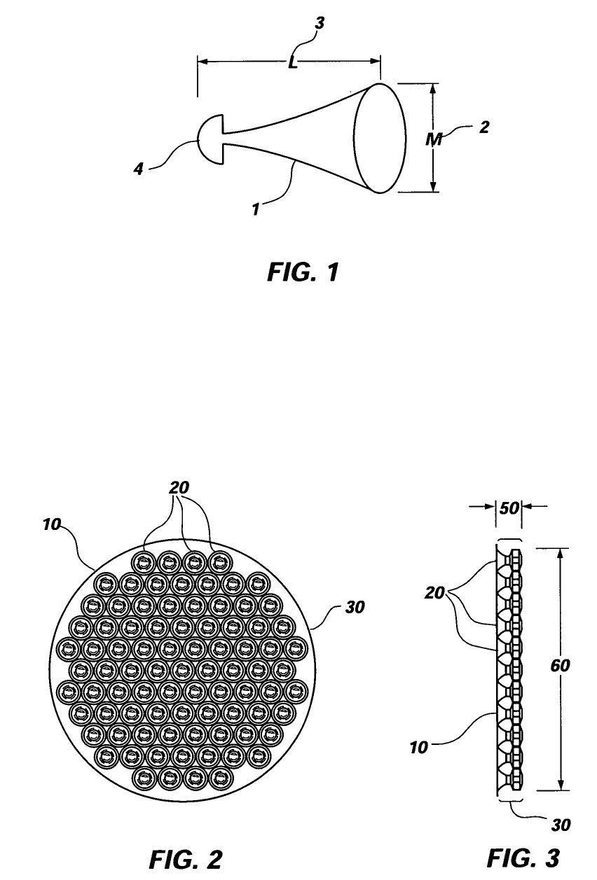

The state of the prior art in high intensity sound generation is shown in FIG. 1. This consists of a basic moving coil horn system 1 with mouth 2 and horn length 3 with moving coil motor 4, which has been the ongoing standard for decades for high output directivity controlled sound generation. While this type of system can be very efficient, they are also well known to be quite large for the wavelengths they are reproducing. To reproduce output in the lower voice ranges, approximately 200 to 800 Hz, these devices require a substantially three dimensional structure that is at least comparable to a wavelength, on the order of one to four feet or more, cumulatively in all three dimensions, including mouth 1 dimension and horn length 2 dimension. To realize multiple units to spread out thermal dissipation in the voice coils of very high output systems, these structures can become quite unwieldy in size and impractical, particularly for any applications requiring portable usage. If designed for higher cutoff frequency the size can be reduced but the output and particularly the directivity suffers significantly.

In one preferred embodiment, as shown in FIG. 2, a frontal view of acoustic system 10 consists of at least one emitter or acoustic emission region 20 mounted on support structure 30. Multiple acoustic emission regions can be staggered for optimal packing density and grouped such that each group is in a different mounting plane. FIG. 3 shows a side view of the same type of structure. In this example 85 piezoelectric bending mode transducers or emitters are utilized by being mounted in the same plane on a compact, substantially two-dimensional structure having a diameter 60 of approximately thirty-three inches and a depth 50 of approximately three inches. This system, optimized for primary acoustic output in the 2.26 kHz to 9.9 kHz frequency range, has a major dimension on the order of 5.5 times the wavelength of its lowest primary frequency or just over 30 inches. The preferred operating frequency of this particular device is approximately 2850 Hz with a wavelength of 4.75 inches, which is about 1/7 of the diameter of the system. Having a diameter or major dimension of at least 4 wavelengths of the lowest primary frequency of maximum output is generally desired in the invention to maintain directivity levels for precise acoustic targeting. Further, this example illustrates in FIG. 3 that the depth 50 is quite small, being on the order of less than one tenth the major dimension or diameter of the device. This small dimension of the system is preferred to be less than one fourth the dimension of the largest dimension of the system. The maximum diameter of the acoustic system can be 0.33 meters, 0.5 meters, or even 0.75 meters or larger. The emitter shape can be square, circular, rectangular, a quadrilateral, or other shape capable of supporting multiple acoustic emission regions.

For one representative embodiment of this type of system the sound pressure level at a reference distance of 2 meters was significantly greater than 140 dB at a range of 2 to 3 kHz during continuous operation, with higher levels achievable at bursts of energy with controlled variations between on and off conditions or level variations over time.

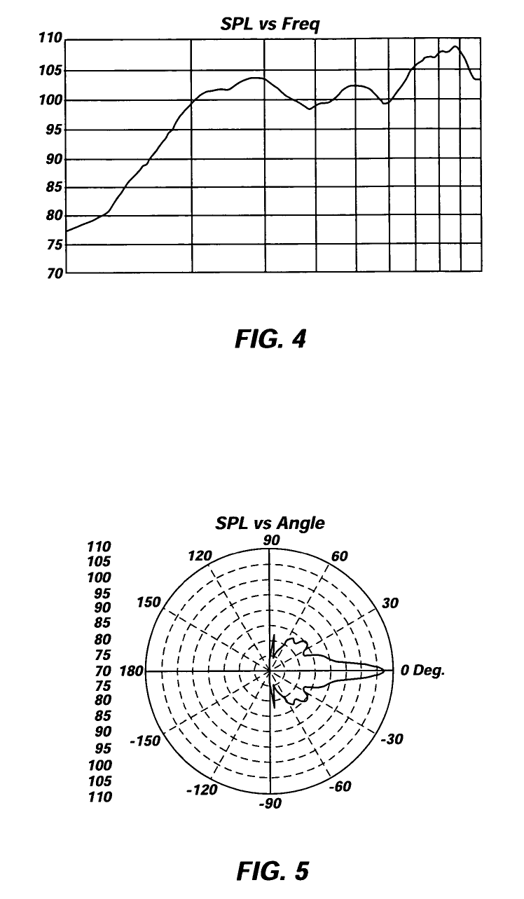

The frequency response of the system at 2 meters is +/−5 dB from 2 kHz to 10 kHz as shown in FIG. 4. The frequency response of the system may have at least one transducer with a resonant frequency in the range of 1000 Hz to 4500 Hz. Alternatively, the resonant frequency of the at least one transducer may be 2000 Hz to 3500 Hz. The at least one transducer may have an initial high pass characteristic of greater than 12 dB per octave. The high pass characteristic of greater than 12 dB per octave may begin in the range of 100 Hz to 4500 Hz. Alternatively, the high pass characteristic of greater than 12 dB per octave may begin in the range of 200 Hz to 3500 Hz.

The polar response of the system is shown in FIG. 5. At 3 kHz the output is down 10 dB at 6 degrees off the center axis of the beam. It is down 20 dB 16 degrees off the center axis. This extreme directivity can be demonstrated easily by powering the device at a safe level, aiming it carefully, and then walking through the beam.

The following table details the continuous sound pressure levels of the embodiment of FIG. 2, measured at various distances.

| | |
|---|---|
| 1 meter | 151 dB |
| 2 meters | 146 dB |
| 5 meters | 137 dB |
| 10 meters | 132 dB |
| 20 meters | 127 dB |
| 40 meters | 122 dB |

Another embodiment of the invention utilizes planar magnetic transduction technology incorporating high-energy magnetic structures, preferably neodymium iron. The planar magnetic transduction systems use thin film or woven diaphragms incorporating conductive runs on the surface or imbedded in the diaphragm, which are suspended adjacent the high energy magnetic structure. The tension on and stiffness of the diaphragm determines the fundamental resonant frequency and frequency region of greatest output of directly radiated acoustic energy.

Another embodiment of the invention incorporates an expanding and contracting piezoelectric film diaphragm with transducer regions formed into arcuate shapes or protuberances. The tension on and the shape of the diaphragm determine the fundamental resonant frequency and frequency region of greatest output of directly radiated acoustic energy.

Any of the embodiments may incorporate a focused array wherein the acoustic emission regions of the system can be configured with the outer areas positioned forward or backward relative to the central acoustic emission regions to form slight convex or concave structures. This can be utilized to a variety of benefits in the inventive device. A focused array can maintain and emphasize directivity over a greater distance, compensate for loss in acoustic output with distance, and can, when desirable, create greater nonlinearity of the air medium or maintain greater nonlinearity of the air medium over a greater distance. In summary, a focused array can be created in the invention by physical displacement of the transducers or by creating virtual placements of the devices with electronic time delays on the central transducer regions relative to the outer transducer regions.

One of the unique features of the invention is to have the ability to drive the air medium to nonlinearity in the audible range allowing the realization of primary audio frequencies f₁ and f₂ with additional secondary frequencies created outside the primary range of the transducer, if desired, through nonlinear parametric conversion with at least some secondary frequencies relating to the difference of the primary frequencies (f₁−f₂),or the sum of the primary frequencies (f₁+f₂).

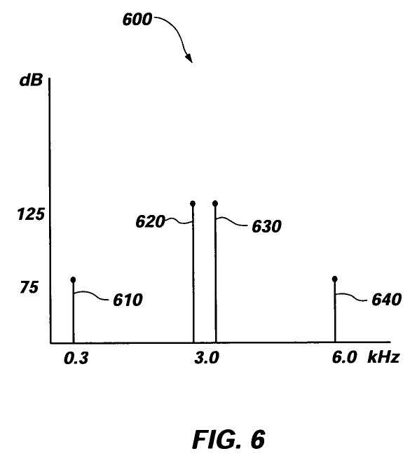

FIG. 6 shows a graph, 600, as an example of the primary and parametrically generated secondary outputs. The graph 600 shows the primary outputs of 129 dB at 2800 and 3100 Hz, 620 and 630 respectively. Also shown is the resultant secondary output 610 generated by the nonlinearity of the air medium with a sound pressure level of 78 dB at 300 Hz. Additionally, the nonlinearity creates a secondary output 640 at 5900 Hz. This is with the air medium driven weakly into nonlinearity. Since the invention has the advantage of operating with the primary signals in the audible range instead of ultrasonically, the saturation levels in the air medium are very low and the primary levels can be increased dramatically without the compression effects that are common in the easily saturated prior art systems. With greater drive signals the saturation can be substantially avoided up to at least 154 dB of primary drive level, which results in a 300 Hz secondary signal of 126 dB, far greater than any prior art parametric system. This can also produce 600 Hz at 138 dB and 1200 Hz at 150 dB, nearly the amount of the primary signals, offering far greater efficiency than any parametric system of the past. Additionally the system can put the primary signals to use since they are in the audible range.

The intensities of the invention can even be generated to a degree that parametric demodulation can be achieved inside the ear canal, creating perceived low frequencies of much greater apparent volume velocities than those actually generated in the air medium. A parametric secondary tone at a frequency at least one octave below the primary frequency may be of greater amplitude than a direct tone radiated at that same frequency for an equivalent voltage input. A parametric secondary tone at a frequency above the primary frequency may be of greater amplitude than a direct tone radiated at that same frequency for an equivalent power input.

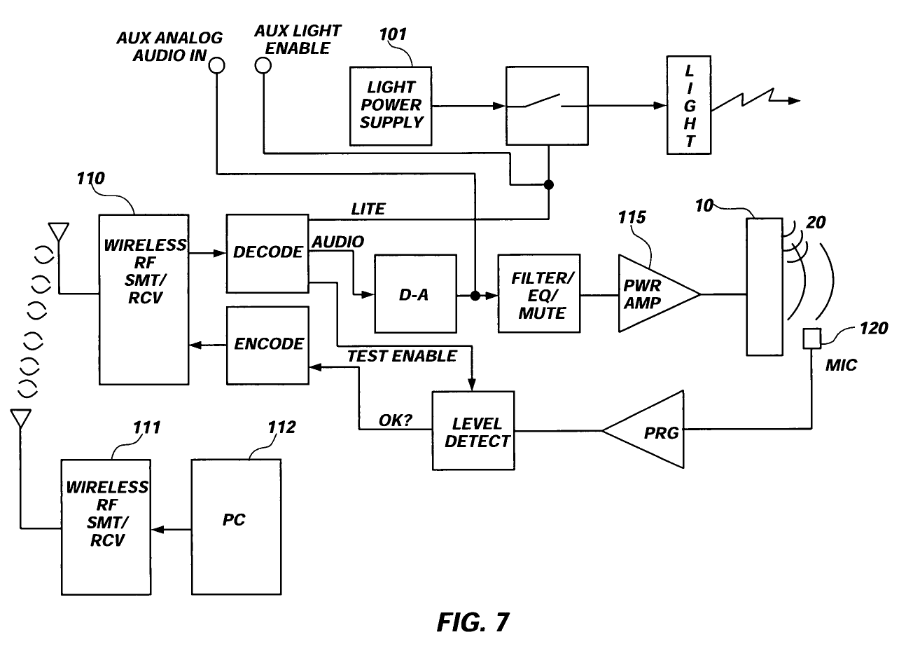

FIG. 7 illustrates a block diagram of a preferred system embodiment. As shown in this embodiment the system may include a light source 100 that may be used for targeting or aiming, as a locator or as a high intensity targeted light source to correspond to the high intensity acoustic targeting. The light source may have a separate power source 101. The system may include a wireless input receiver 110 to receive control signals or program signals to be reproduced acoustically. The signal input to this RF receiver may come from a wireless transmitter 111 that may be operated from a computer 112. Various control functions and processing are available and would be delivered to power amp 115 which drives the acoustic sound generator 10 with acoustic emission regions 20. Sensor 120, shown here as a microphone, may transmit information about the output signal back to the signal processing portion of the system to calibrate or adapt to conditions as preferred, adjusting levels, phase relationships, etc. Feedback from sensor 120 may be used to maintain predetermined level maximums, predetermined time-energy maximums, predetermined signal rise times, and predetermined signal decay times. Power amplifier 115, in a preferred embodiment, is a high efficiency switching amplifier adapted to receive at least an audio signal.

The sound generation system can also produce harmonic content that can psycho-acoustically create a significant perception of a missing fundamental tone that would be the fundamental related to the generated harmonics.

In a preferred embodiment, the system can provide high directivity over the primary or secondary sound generating range of the system, maintaining substantially consistent directivity even at frequencies with wavelengths comparable to or larger than the dimensions of the sound generation system.

A further feature of the system would be to incorporate an ability to pulse the desired signal on and off or at variable intensity levels to create greater peak levels while maintaining a lower thermal rise in the transducer system, minimize compression effects and increase transducer reliability. In one embodiment, the desired signal can be pulsed by varying the audio signal to the power amplifier 115 (see FIG. 7). Additionally, the pulsing rate may be coordinated with that of the human auditory system to keep hearing sensitivity as high as possible during reception of acoustic signals from the invented device. This function is calibrated to correlate to the ear's ability to shut down its sensitivity if larger continuous signals are being received such that the ear will hear the continuous signal as reduced in level. By pulsing a signal at a predetermined repetition rate, this compression of hearing mechanism sensitivity can be minimized.

The system can be utilized as a non-lethal weapon or deterrent by directing high intensity acoustic energy above the threshold of pain towards a human target. The onset of the threshold of pain is in the range of 120 to 130 dB with the ear's sensitivity being greatest in the region near 3 kHz. This can be further refined in that the ear has a time and intensity control function that shuts down the ear's sensitivity when loud sounds are sustained. By controlling the duration and amplitude or turning the system on and off at a predetermined repetition rate, the ear's sensitivity can be maintained close to that of the threshold in a silent environment. An example of a desired repetition rate would be one second on and one second off tone bursts of the desired frequency or frequencies.

Due to the very high intensities of the system it may be important to protect the operator by further minimizing all side lobe and rearward acoustic radiation. This can be achieved by applying a bounding shroud structure or side shield that is comparable to the primary frequency wavelengths. In the inventive system this will be able to also minimize rearward radiation of longer wavelength frequencies below the transducer cutoff frequency and those comparable or larger than the largest dimension of the system due to audio band primary and secondary frequency generation all being dependent only on the primary frequency wavelengths. The bounding shroud structure can also minimize side-lobe radiation and rear radiation to protect the user and maximize forward radiation directivity.

Due to the high intensity levels available from the device, it can be useful to incorporate a novel system to set or automatically adapt to predetermined sound pressure level maximums, standards or regulations, such as those of OSHA. These can be time/intensity based control functions. They may also have slower rise times to allow the ear to adapt to the high intensity before the system reaches a maximum level. This may be used to avoid hearing damage while still achieving adequate levels for intense communications, disruption, discomfort or other psychophysical acoustic goals.

The system may be invoked to maximize auditory discomfort and disruption of communications via radio and to create interpersonal physical effects.

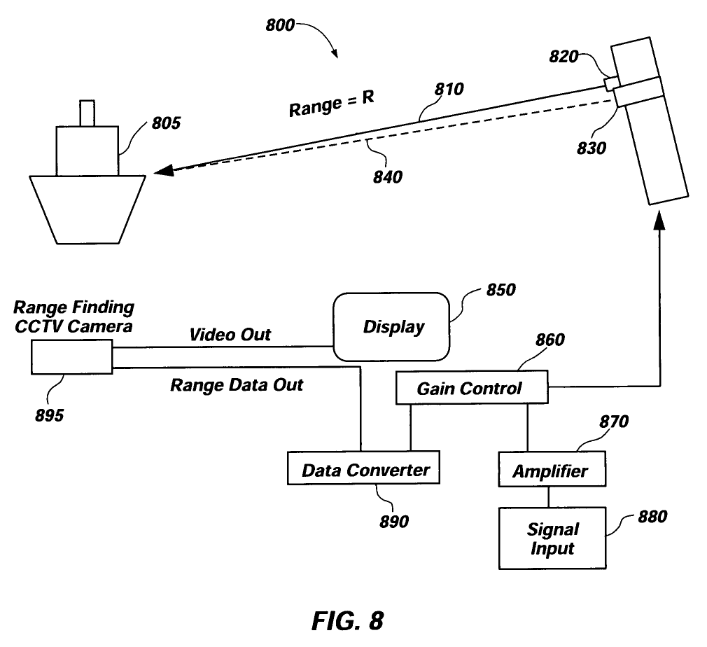

FIG. 8 shows an embodiment using a range finder 830 incorporated with the system to determine distances for the optimization of sound level or sound focusing parameters and calibration. In the example in FIG. 8, a range finding CCTV camera 895 can be used to determine the distance 840 to the object 805 at which the system will be directed. The CCTV camera can also be used to show the object on a display 850. The range data can be sent out of the CCTV camera through a data converter 890 to a gain control 860. The gain control can adjust the amplifier 870 to alter the signal input 880 according to the range detected. The sound generator system can then be calibrated at a level relative to the distance from the object. An aiming feature 820 may be included with the range finder for applying maximum acoustic energy at a specific target. The aiming feature may be a camera mounted on the sound generator with an associated viewing screen. The viewing screen may be located remote from the sound generator. The aiming feature may include a laser-type pointing device, a crosshair or bead site structure, and a magnifying optical lens.

FIG. 10 shows a sound generator system where multiple emitting sections on different planes 1000 are used for focusing or steering the emitted wave. An inner emitting section 1004 may have an outer ring 1006 that is raised or lowered in height compared to the inner emitting section. A ring 1008, exterior to outer ring 1006, may be raised or lowered in height compared to the outer ring 1006. Physically displaced and/or electronically delayed inner and outer emitting sections of the sound generator system may be altered to create an effective concave or convex acoustic projection source to optimize in phase energy at a predetermined distance, create a greater directivity or to disperse the sound in a predetermined manner.

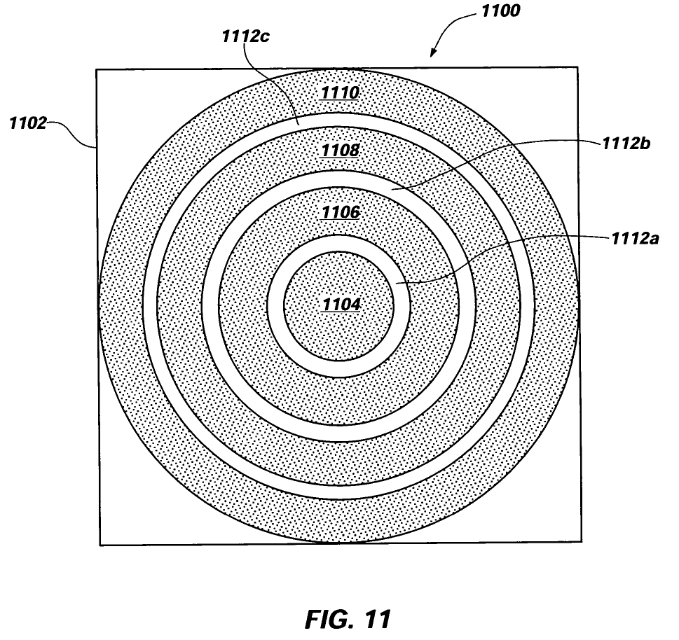

FIG. 11 shows a sound generator system 1100 where the inner emitting section 1104 may be electronically delayed from the outer emitting section 1106. Each emitting section may be comprised of a plurality of smaller individual emitters, such as bimorph emitters or sound horns. In more complex systems, multiple outer ring emitting sections 1108 and 1110 may be employed, wherein the electronic signal applied to each emitting section is delayed by a differing amount. By strategically sizing each of the emission ring sections, and by varying the phases of the electronic signals applied to each section, the projected wave may be optimized at the predetermined distance.

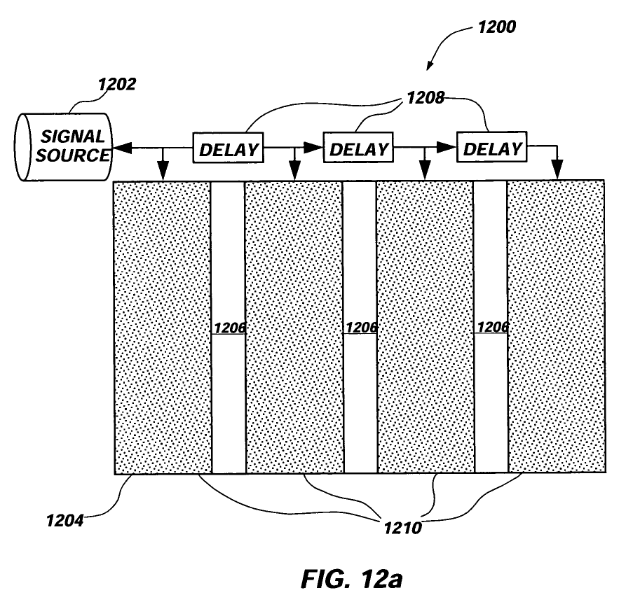

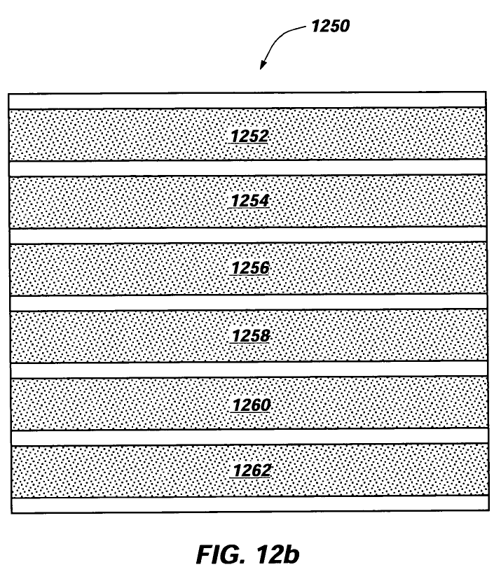

In another embodiment, shown in FIGS. 12a and 12b, a similar approach may be incorporated to beam steer the projected wave in various target directions without having to physically move or reorient the system. The sound generator system 1200 may include at least two adjacent emitting sections 1210, wherein each emitting section is delayed by a differing amount. The direction of the propagated wave is a function of the size of each emitting section and the phase delays of the electronic signals applied to the emitting sections. This adaptation may be coordinated with the range finder function shown in FIG. 8. Beam steering or mechanical reorienting of the emitter can be applied on the side of a ship to counter beam displacement resulting from ocean wave movement. A feedback system can adjust the orientation of the emitter relative to the target, maintaining a fixed projection of sound at the target despite the rhythmic undulation of the ship.

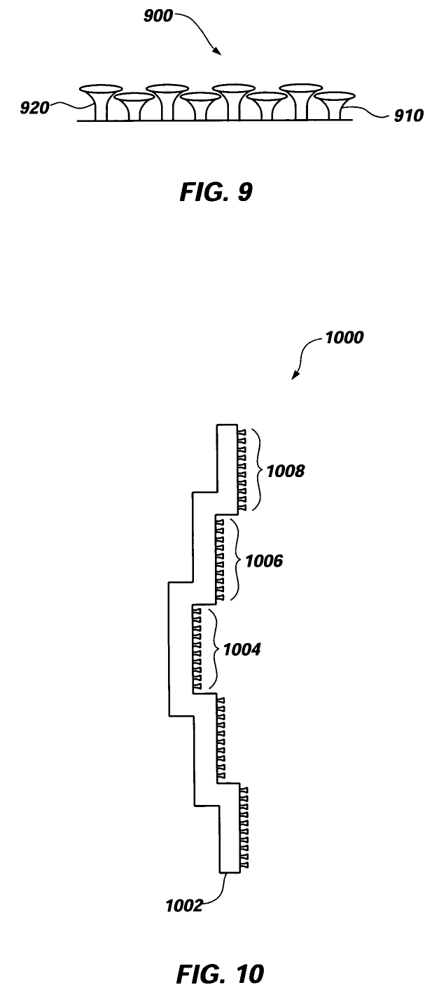

FIG. 9 illustrates that individual transducers or transducer areas may be staggered front to back 900. Staggering the transducers so that there is at least a first more forward plane of transducers 920 and at least a second more rearward plane of transducers 910 allows greater packing density to maximize packing density for greater output capability. This may be done in a manner that focuses or disperses the directivity in a predetermined manner. Delays may be applied to some transducer acoustic emission regions relative to other transducer acoustic emission regions of the system to maintain the desired phase relationships of the various transducer acoustic emission regions regardless of their physical orientation or relation to each other. At least two groups of acoustic emission regions in one plane relative to another plane can be driven in different phase relationships to maximize axial summation of output in the far field. Far field will be discussed in more detail below.

Resonant pipes, waveguides, horns or other means may be incorporated to maximize transducer area output over a narrow range to trade primary bandwidth for output while optionally still being able to provide greater bandwidth than the primary output through the generation of nonlinearly produced secondary outputs at frequencies outside of those of the primary output.

Quarter wave pipes or waveguides may be incorporated which emphasize every odd quarter wavelength frequency. This approach may be supplemented with secondary parametric output producing desired frequencies between each odd quarter wavelength where primary output is less efficient.

Output may be further optimized through narrow band high Q resonance, much greater than Q=1, including greater than Q=7, to increase primary output narrow band and to optionally still provide wide band secondary parametric output. The narrow bandwidth can correspond to a frequency in the range of maximum sensitivity of a human auditory system, to generate a directed high intensity sound beam with an axial acoustic output of at least 140 dB at a minimum of 2 meters.

With various preferred embodiments, secondary parametric output frequencies can be generated below the resonant frequency of a transducer with the same (or greater with hi-Q) output as if they were directly generated at the lower frequencies but with greater directivity.

The system in FIG. 2, as an example, can produce greater parametric output below a transducer cutoff frequency range of 2 to 3 kHz when primary output is greater than approximately 133 dB. At 133 dB primary output near 3 kHz the system will generate 81 dB of secondary output at 300 Hz, which approximately equals the primary output capability of the system. For each increase of 1 dB in the output of the invented system example, 2 dB of secondary output increase is realized. Prior art parametric systems cannot match this level advantage on an ongoing output increase basis due to saturation effects at ultrasonic frequencies compressing the secondary output down to a 1 to 1 relationship with the primary increase in output. The invented system can avoid saturation compression at levels of approximately 24 dB greater than prior art parametric system. In one preferred embodiment, this can allow substantial avoidance of saturation at levels up to 154 to 164 dB, or greater, as compared to 130 to 140 dB in prior art parametric systems. This 24 dB advantage is quite dramatic in that it can allow the invented system to generate as much as 48 dB greater secondary, or parametric sound pressure level, than any previous parametric sound generator. This can result in secondary outputs in the lower voice range (200 to 800 Hz) of over 126 dB and secondary outputs of greater than 140 dB in the middle voice ranges of 800 to 2 kHz or more.

A hybrid embodiment of the invention could incorporate an ultrasonic based parametric system to radiate only secondary information in the audible range in conjunction with the audio based acoustic system disclosed herein. The primary audio range system could be realized as a ring radiator around an ultrasonic parametric communication device and/or the parametric could also fold up to allow more primary system area, be placed in front of or inter-dispersed within the primary system acoustic emission regions or even be formed as a ring around the outside of the primary system.

In a preferred embodiment it can be advantageous to utilize capacitive or piezoelectric transducer technology to maximize output and minimize thermal rise due to resistive impedances that can dominate non-capacitive transducers.

Alternatively, planar magnetic or dynamic moving coil transducers can be used to realize the invention.

When using reactive impedance transducers it can be highly desirable to incorporate impedance matching networks between the power source and the transducer to minimize reactive circulating currents from flowing through or being sourced from the power source. This matching may be done over a narrow bandwidth near the transducer resonant frequency or a dominant primary frequency to be generated.

It is desirable to optimize the invention for use in the far field, a distance that is a significant multiple of the largest dimension of the sound generator itself. This can be done though the focusing methods discussed elsewhere in this disclosure with a preferred embodiment having maximum phase coherency summation of the majority of system acoustic emission regions coordinated with a far field target at least ten or more system dimensions away from the sound generation system and often 20 to 100 or more maximum dimensions in distance. Creating maximum phase coherency in the far field may be accomplished using the embodiments of FIGS. 10, 11, 12a and 12b.

The system operates with a directive column in the near field, a distance comparable to or less than the largest dimension of the system and also operates and is preferably used to generate a directional column of sound in the far field, a distance many times that of the largest dimension of the system.

Various acoustic signals may be communicated through the device, including frequency or amplitude modulated signals or combination tones to create a specific affect on the target.

In a preferred embodiment of the invented sound generator, the directed high intensity sound beam is capable of intensity greater than what is linearly sustainable in an air medium. The sound generator, when delivering at least two primary acoustic signal frequencies in an audible range, can create at least one secondary acoustic signal in a lower audible frequency range corresponding to a difference tone frequency of the two primary acoustic signal frequencies (see FIG. 6). One of the advantages of the invention is that at least one of the at least one secondary acoustic signals in a lower audible range can be at a frequency that is closer to the primary frequency than would be so in prior art parametric loudspeakers and therefore the volume velocity of the primary signal can more closely relate to the volume velocity of a similar sound pressure level at the lower frequency secondary signal. With prior art parametric systems operating with carrier frequencies on the order of 40 kHz or greater the volume velocity of the primary signal is very small compared to that of the parametrically generated secondary audible tones, due to the fact that the secondary tones are at least 20 kHz removed from the primary signal.

The invented sound generator can be operable as a parametric loudspeaker with primary and secondary frequencies both generated in the range of human hearing. In the system of the invention the parametrically generated secondary acoustic signals are at least less than 10 kHz below at least one of the primary tones. More likely at least one of the at least one secondary acoustic signals in a lower audible range is less than 3.5 to 7 kHz below at least one of the primary tones.

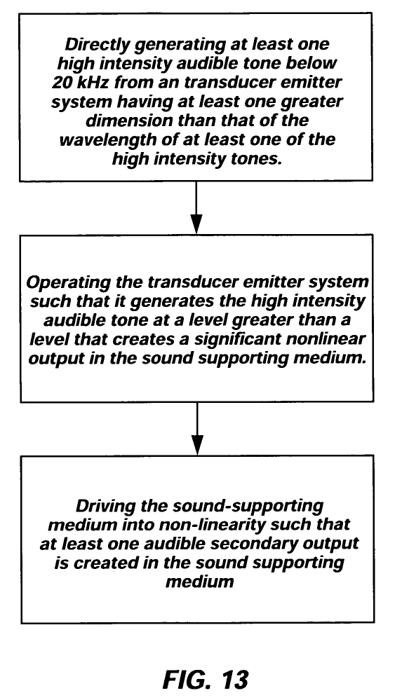

FIG. 13 illustrates another embodiment of the present invention that includes a method for generating highly directional acoustic signals in the audio range of both direct and secondary parametric acoustic generation in a sound-supporting medium. The method includes the step of directly generating at least one high intensity audible tone below 20 kHz from an transducer emitter system having at least one dimension that is greater than that of the wavelength of at least one of the high intensity tones in block 1310. A further operation is operating the transducer emitter system such that it can generate the directly generated audible tone at a level greater than a level that creates a significant nonlinear output in the sound supporting medium in block 1320. Another operation is driving the sound-supporting medium into nonlinearity such that at least one audible indirect secondary output is created in the sound supporting medium in block 1330.

The above method offers a further advantage when the at least one audible secondary acoustic output is less than 10 kHz below the at least one high intensity audible tone. It can offer even further improvement in output when the at least one audible secondary output is less than 3.5 to 5 kHz below the at least one high intensity audible tone.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

1. An electro-acoustic sound generator system for generating a high intensity directional sound column in a far field comprising:
an acoustic emitter with at least one transducer acoustic emission region;
at least one power amplifier channel adapted to receive at least an audio signal;
at least a length of the emitter being scaled to be at least four times a wavelength of a lowest frequency of at least one maximum acoustic output primary acoustic signal;
at least a depth of the emitter being scaled to be less than one fourth the dimension of the length; and
the emitter being configured and tuned to exhibit high efficiency over at least a narrow bandwidth corresponding to a frequency range of maximum sensitivity of a human auditory system, to generate a directed high intensity sound beam with an axial acoustic output of at least 140 dB at a minimum of 2 meters.

2. The sound generator of claim 1 wherein the acoustic emitter consists of multiple transducer acoustic emission regions.

3. The sound generator of claim 2 wherein the multiple acoustic transducer emission regions are staggered for optimal packing density and grouped such that each group is in a different mounting plane.

4. The sound generator of claim 3 wherein at least two groups of transducers in one plane relative to another plane are driven in different phase relationships to maximize axial summation of output in the far field.

5. The sound generator of claim 1 wherein at least one primary acoustic signal is between 1500 and 4000 Hz.

6. The sound generator of claim 5 wherein the length of the acoustic emitter is at least 0.33 meter.

7. The sound generator of claim 5 wherein the length of the acoustic emitter is at least 0.5 meters.

8. The sound generator of claim 5 wherein the length of the acoustic emitter is at least 0.75 meters.

9. The sound generator of claim 5 wherein the emitter is substantially circular in form and has a diameter of at least 0.75 meters.

10. The sound generator of claim 5 wherein the emitter is substantially rectangular in form and has a cross section of at least 0.5 square meters.

11. The sound generator of claim 1 wherein the directed high intensity sound beam is capable of intensity greater than what is linearly sustainable in an air medium.

12. The sound generator of claim 11 wherein the emitter is configured to generate at least two primary acoustic signal frequencies in an audible range that create at least one secondary acoustic signal in a lower audible frequency range corresponding to a difference tone frequency of the two primary acoustic signal frequencies.

13. The sound generator of claim 11 wherein the emitter is configured to generate at least two primary acoustic signal frequencies in an audible range that creates at least one secondary acoustic signal in an upper audible range frequency corresponding to a sum tone frequency of the two primary acoustic signal frequencies.

14. The sound generator of claim 1 wherein the sound generator is operable as a parametric loudspeaker with primary and secondary frequencies both generated in the range of human hearing.

15. The sound generator of claim 1 wherein the primary acoustic signals are pulsed at a predetermined repetition rate.

16. The sound generator of claim 15 wherein the predetermined repetition rate corresponds to a rate that reduces a thermal rise in the emitter to a value that minimizes compression effects and increases transducer reliability.

17. The sound generator of claim 15 wherein the predetermined repetition rate corresponds to a rate that maintains continuous maximum sensitivity in a targeted human auditory system.

18. The sound generator of claim 1 further comprising a bounding shroud structure to minimize side-lobe radiation and rear radiation to maximize forward radiation directivity.

19. The sound generator of claim 1 further comprising a level monitoring and level setting system to maintain predetermined level maximums.

20. The sound generator of claim 1 further comprising a level monitoring and level setting system to maintain predetermined time-energy maximums.

21. The sound generator of claim 1 further comprising a level monitoring and level setting system to maintain predetermined signal rise times.

22. The sound generator of claim 1 further comprising a level monitoring and level setting system to maintain predetermined signal decay times.

23. The sound generator of claim 1 further incorporating a range finder.

24. The sound generator of claim 19 further including a level relative to distance calibration.

25. The sound generator of claim 23 further including a level relative to distance calibration.

26. The sound generator of claim 1 further comprising:
at least an inner emitter area and at least an outer emitter area: and
an electronic delay function independently controlling the at least one inner emitter area relative to the outer emitter area for optimizing the phase of the total emitter for maximum acoustic output at a given distance.

27. The sound generator of claim 23 further comprising:
at least an inner emitter area and at least an outer emitter area: and
an electronic delay function independently controlling the at least one inner emitter area relative to the outer emitter area for optimizing the phase of the total emitter for maximum acoustic output at a given distance.

28. The sound generator of claim 1 further comprising:
at least an inner emitter area and at least an outer emitter area: and
an electronic delay function independently controlling the at least one inner emitter area relative to the outer emitter area for optimizing the phase of the total emitter for maximum acoustic directivity at a given distance.

29. The sound generator of claim 23 further comprising:
at least an inner emitter area and at least an outer emitter area: and
an electronic delay function independently controlling the at least one inner emitter area relative to the outer emitter area for optimizing the phase of the total emitter for maximum acoustic directivity at a given distance.

30. The sound generator of claim 1 further comprising:
at least an inner transducer area and at least an outer transducer area on the emitter: and
an electronic delay function independently controlling the at least one inner transducer area relative to the outer transducer area for optimizing the phase of the total emitter to control acoustic directivity.

31. The sound generator of claim 23 further comprising:
at least an inner transducer area and at least an outer transducer area on the emitter: and
an electronic delay function independently controlling the at least one inner transducer area relative to the outer transducer area for optimizing the phase of the total emitter to control acoustic directivity.

32. The sound generator of claim 1 further comprising:
at least two adjacent transducer areas on the emitter; and
an electronic delay function independently controlling the at least the first adjacent transducer area relative to the at least a second transducer area for optimizing the phase of the total emitter for maximum acoustic output at a given angle.

33. The sound generator of claim 1 further comprising:
an array of multiple acoustic emission regions forming an emitter face;
said multiple acoustic emission regions alternately staggered in at least a first more forward plane and second more rearward plane in a front to back relationship to maximize packing density for a maximum number of acoustic emission regions forming the emitter.

34. The sound generator of claim 33 wherein the set of transducers in the at least a first more forward plane are time delayed relative to the set of transducers in the at least second more rearward plane to optimize the phase relationship of the at least two planes of transducers areas for maximum output at a far field.

35. The sound generator of claim 1, further comprising:
at least one transducer with enhanced efficiency in range of high sensitivity in human hearing, said enhancement derived from the employment of a high Q transducer resonance in the range of highs sensitivity in human hearing.

36. The sound generator of claim 35 wherein the resonant frequency of the at least one transducer is in the range of 1000 Hz to 4500 Hz.

37. The sound generator of claim 35 wherein the resonant frequency of the at least one transducer is in the range of 2000 Hz to 3500 Hz.

38. The sound generator of claim 1 wherein the at least one transducer acoustic emission region has an initial high pass characteristic of greater than 12 dB per octave.

39. The sound generator of claim 38 wherein the high pass characteristic of greater than 12 dB per octave begins in the range of 1000 Hz to 4500 Hz.

40. The sound generator of claim 38 wherein the high pass characteristic of greater than 12 dB per octave begins in the range of 2000 Hz to 3500 Hz.

41. The sound generator of claim 1 further comprising an aiming feature for applying maximum acoustic energy at a specified target.

42. The aiming feature of claim 41 wherein said feature includes a camera mounted on the sound generator and an associated viewing screen.

43. The aiming feature of claim 42 wherein the viewing screen is located remote from the sound generator.

44. The aiming feature of claim 41 wherein said feature includes a laser-type pointing device.

45. The aiming feature of claim 41 wherein said feature includes a crosshair or bead site structure.

46. The aiming feature of claim 41 wherein said feature includes a magnifying optical lens.

47. The sound generator of claim 12 wherein a parametric secondary tone at a frequency at least one octave below the primary frequency is of greater amplitude than a direct tone radiated at that same frequency for an equivalent voltage input.

48. The sound generator of claim 13 wherein a parametric secondary tone at a frequency above the primary frequency is of greater amplitude than a direct tone radiated at that same frequency for an equivalent power input.

49. The sound generator of claim 12 wherein at least one of the at least one secondary acoustic signal in a lower audible range is less than 10 kHz below at least one of the primary tones.

50. The sound generator of claim 12 wherein at least one of the at least one secondary acoustic signal in a lower audible range is less than 7 kHz below at least one of the primary tones.

51. The sound generator of claim 12 wherein at least one of the at least one secondary acoustic signal in a lower audible range is less than 5 kHz below at least one of the primary tones.

52. The sound generator of claim 12 wherein at least one of the at least one secondary acoustic signal in a lower audible range is less than 3.5 kHz below at least one of the primary tones.

53. A method for generating highly directional acoustic signals in the audio range of both direct and secondary parametric acoustic generation in a sound-supporting medium with said method including the steps of:
a) directly generating at least one high intensity audible tone below 20 kHz from an transducer emitter system having at least one dimension that is greater than that of the wavelength of at least one of the high intensity audible tones;
b) operating the transducer emitter system such that it generates the high intensity audible tone at a level greater than a level that creates a significant nonlinear output in the sound supporting medium; and
c) driving the sound-supporting medium into nonlinearity such that at least one audible secondary output is created in the sound supporting medium.

54. The method of claim 53 wherein the at least one audible secondary acoustic output is less than 10 kHz below the at least one high intensity audible tone.

55. The method of claim 53 wherein the at least one audible secondary acoustic output is less than 5 kHz below the at least one high intensity audible tone.

56. The method of claim 53 wherein the at least one audible secondary acoustic output is less than 3.5 kHz below the at least one high intensity audible tone.

57. An electro-acoustic sound generator system for generating a high intensity directional sound column in a far field comprising:
at least one power amplifier channel adapted to receive an audio signal;
an acoustic emitter having a pass-band region tuned to at least a frequency range of maximum sensitivity of a human auditory system, and having a known high-pass cutoff frequency; and
an emission surface having a length of at least four times a wavelength of the high-pass cutoff frequency for enabling high intensity propagation of a directional sound column for frequencies greater than the high-pass cutoff frequency, and having a depth no greater than one-forth of the length of the emission surface wavelength of the high-pass cutoff frequency.

58. The sound generator of claim 57, wherein at least harmonic content of the audio signal is propagated in a high intensity directional sound column by the acoustic emitter.

59. An electro-acoustic sound generator system to be used as a non-lethal weapon, comprising:
at least one power amplifier channel adapted to receive at least an audio signal;
an acoustic emitter capable of emitting two primary waves in the audible frequency range, wherein the length of the emitter is at least four times a wavelength of the lowest frequency of the primary waves, and the depth of the emitter is less than one forth the wavelength of the length lowest frequency of the acoustic emitter, wherein the dimensions of the emitter enable the primary waves to be propagated in a directional column of sound;
wherein the two primary frequencies are emitted at a sufficient level to drive surrounding air into nonlinearity, thereby creating a secondary wave having a frequency equal to the difference of the two primary wave frequencies; and
wherein the primary and secondary waves are at a sufficiently high intensity level to cause pain to a human target.

60. The sound generator of claim 59, further including an aiming device, for directing the directional column of sound towards the human target.
